(19) United States
(12) Patent Application Publication
(10) Pub. No.: US 2005/0141434 A1
(43) Pub. Date: Jun. 30, 2005

(54) Method, system, and program for managing buffers

(76) Inventor: Linden Cornett, Portland, OR (US)

Correspondence Address: KONRAD RAYNES & VICTOR, LLP, 315 S. BEVERLY DRIVE, # 210, BEVERLY HILLS, CA, 90212, US

(21) Appl. No.: 10/746,068

(22) Filed: Dec. 24, 2003

(51) Int. Cl. H04L 12/26

(52) U.S. Cl. 370/252; 370/466

(57) ABSTRACT

Provided are a method, system, and program for managing buffers. In one embodiment, a device such as a network adapter, receives data such as a packet from a network and selects a receive buffer from an input queue of different types of input descriptors. Included in the input queue are receive buffer input descriptors each of which includes the physical address of a receive buffer and a control structure identifier of a control structure associated with the receive buffer. The device transfers the received data to the selected receive buffer and stores a receive buffer control structure identifier in a receive buffer output descriptor which is stored in an output queue of other output descriptors. In one embodiment, a driver for the device reads a receive buffer output descriptor from the output queue and processes the data transferred to the receive buffer using the receive buffer control structure identified by the receive buffer control structure identifier of the read receive buffer output descriptor.

### BACKGROUND OF THE INVENTION

1. Field of the Invention

The present invention relates to a method, system, and program for managing buffers including receive buffers for a network adapter.

2. Description of the Related Art

In a network environment, a network adapter on a host computer, such as an Ethernet controller, Fibre Channel controller, etc., will receive Input/Output (I/O) requests or responses to I/O requests initiated from the host. Often, the host computer operating system includes a device driver to communicate with the network adapter hardware to manage I/O requests to transmit over a network. The host computer may also implement a protocol which packages data to be transmitted over the network into packets, each of which contains a destination address as well as a portion of the data to be transmitted. Data packets received at the network adapter are often stored in an available allocated packet buffer in the host memory. A transport protocol layer can process the packets received by the network adapter that are stored in the packet buffer, and access any I/O commands or data embedded in the packet.

For instance, the computer may implement the Transmission Control Protocol (TCP) and Internet Protocol (IP) to encode and address data for transmission, and to decode and access the payload data in the TCP/IP packets received at the network adapter. IP specifies the format of packets, also called datagrams, and the addressing scheme. TCP is a higher level protocol which establishes a connection between a destination and a source. Another protocol, Remote Direct Memory Access (RDMA) establishes a higher level connection and permits, among other operations, direct placement of data at a specified memory location at the destination.

A device driver, application or operating system can utilize significant host processor resources to handle network transmission requests to the network adapter. One technique to reduce the load on the host processor is the use of a TCP/IP Offload Engine (TOE) in which TCP/IP protocol related operations are implemented in the network adapter hardware as opposed to the device driver or other host software, thereby saving the host processor from having to perform some or all of the TCP/IP protocol related operations. The transport protocol operations include packaging data in a TCP/IP packet with a checksum and other information, and unpacking a TCP/IP packet received from over the network to access the payload or data.

Network adapter hardware including offload engines, and other devices as well, frequently utilize memory, often referred to as a buffer, to store or process data. Buffers have been implemented using physical memory which stores data, usually on a short term basis, in integrated circuits, an example of which is a random access memory or RAM. Typically, data can be accessed relatively quickly from such physical memories. A host computer often has additional physical memory such as hard disks and optical disks to store data on a longer term basis. These nonintegrated circuit based physical memories tend to retrieve data more slowly than the integrated circuit physical memories.

The operating system of a computer typically utilizes a virtual memory space which is often much larger than the memory space of the physical memory of the computer. As a portion of the virtual memory space is being used, it may be mapped to either a portion of the short term physical memory space or a portion of the long term physical memory space.

To make buffers available to hardware such as a network adapter, known systems provide in the host memory a receive queue, an example of which is shown in FIG. 1. The receive queue 50 includes a list of receive buffer descriptors 52a, 52b . . . each of which includes fields 72, 74 which define the buffer size and buffer physical address, respectively. As a network adapter receives packets, the network adapter accesses the receive queue 50 to obtain a receive buffer physical address, and stores the received packet in the receive buffer at the specified physical address. As each receive buffer identified in the output queue 50 is filled, the network adapter writes a completion descriptor 78a, 78b . . . in an output queue 80, also typically located in the host memory. Each completion descriptor typically includes a field 82 defining the physical address of the receive buffer in which the received packet was stored by the network adapter.

In response to a completion descriptor being written into the output queue 80, the network adapter driver typically processes the packet stored in the receive buffer at the specified physical address. Network adapter hardware logic often uses physical addresses rather than virtual addresses. However, many network adapter drivers tend to utilize virtual addresses rather than physical addresses. Hence, the physical address specified in the completion descriptor in the output queue 80 may not provide to the device driver an efficient identification of the filled receive buffer.

However, many prior network adapters often process the receive buffers posted to the receive queue 50 in the order in which the receive buffer descriptors 52a, 52b . . . are posted by the driver. Hence, the network adapter hardware typically posts the completion descriptors 78a, 78b . . . to the output queue 80 in the same order in which the associated receive buffer descriptors 52a, 52b . . . are posted by the driver to the receive queue 50. In such prior systems, the driver can typically readily identify the filled receive buffer by the position of the associated completion descriptor 78a, 78b . . . in the output queue 80.

The network adapter driver typically processes the packet stored in the filled receive buffer using a data structure often referred to as a control structure. Thus, each receive buffer often has an associated receive buffer control structure 88a, 88b . . . which includes various fields including the receive buffer virtual address, physical address, size and other fields such as packet structure information. In systems in which the network adapter hardware posts the completion descriptors 78a, 78b . . . to the output queue 80 in the same order in which the associated receive buffer descriptors 52a, 52b . . . are posted by the driver to the receive queue 50, the driver can create and store the control structures 88a, 88b . . . in a queue 90 in the same order as the associated receive buffer descriptors 52a, 52b . . . are stored in the queue 50 by the driver and the associated completion descriptors 78a, 78b . . . are stored by the hardware in the output queue 80. As a result, the driver can identify the control structure 88a, 88b . . . of each filled receive buffer by the position of the associated completion descriptor 78a, 78b . . . in the output queue 80. Thus, the queues 50, 80 and 90 can each be operated as relatively simple first-in, first-out (FIFO) queues.

Notwithstanding, there is a continued need in the art to improve the performance of memory usage in data reception and other operations.

### BRIEF DESCRIPTION OF THE DRAWINGS

Referring now to the drawings in which like reference numbers represent corresponding parts throughout:

FIG. 1 illustrates prior art queues for receive buffer descriptors, receive buffer control structures and completion descriptors;

FIG. 2 illustrates one embodiment of a computing environment in which aspects of the invention are implemented;

FIG. 3 illustrates a prior art packet architecture;

FIG. 4 illustrates one embodiment of queues for receive buffer descriptors, and completion descriptors in accordance with aspects of the invention;

FIG. 5 illustrates one embodiment of operations performed to store data in receive buffers in accordance with aspects of the invention;

FIG. 6 illustrates one embodiment of operations performed to process an output queue containing buffer output descriptors in accordance with aspects of the invention; and

FIG. 7 illustrates an architecture that may be used with the described embodiments.

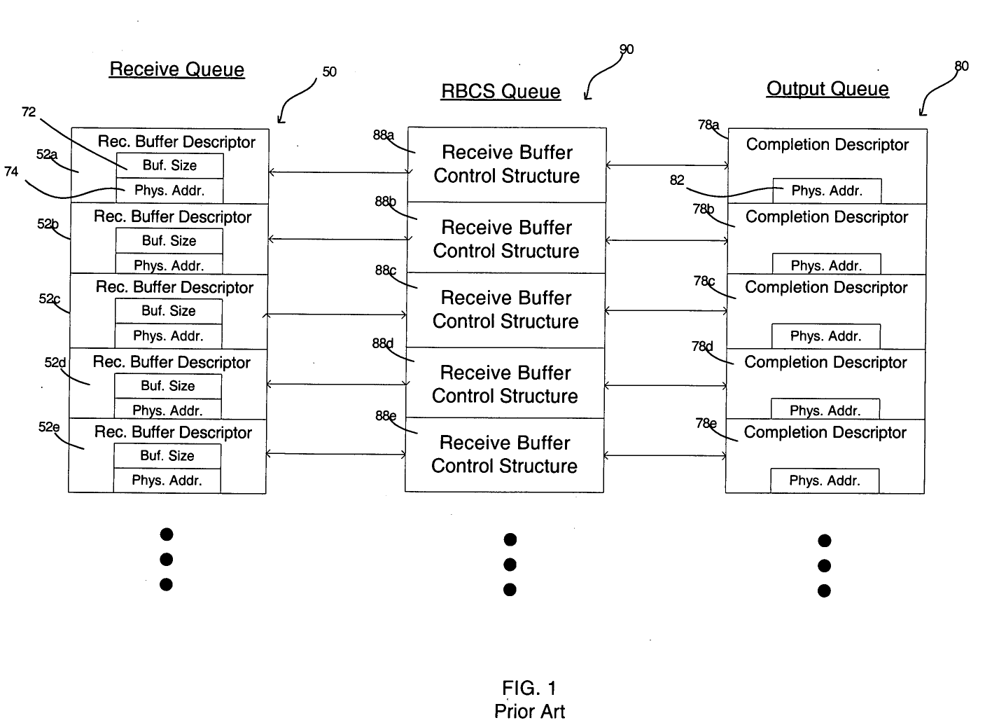

### DETAILED DESCRIPTION OF THE ILLUSTRATED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

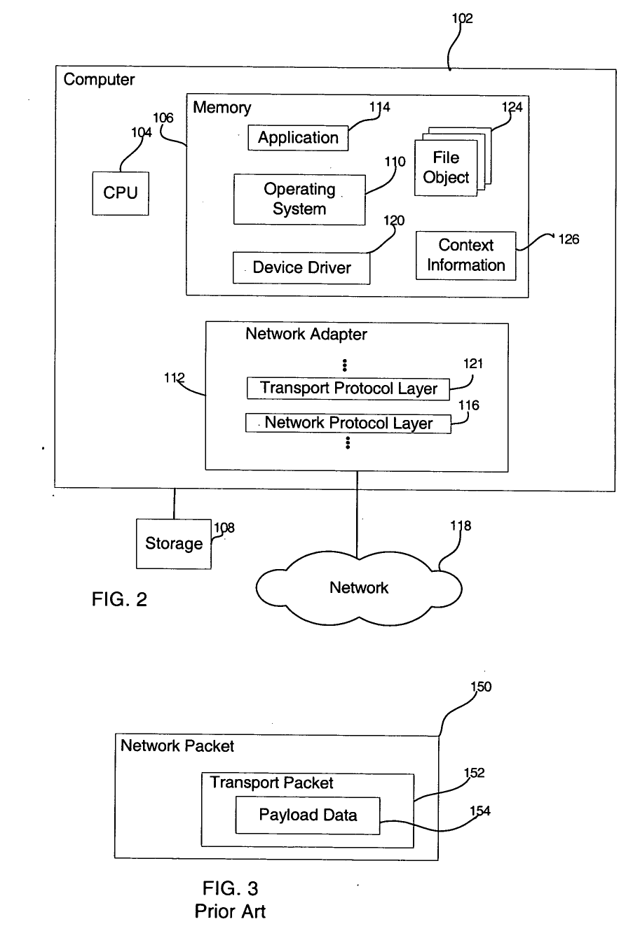

FIG. 2 illustrates a computing environment in which aspects of the invention may be implemented. A computer 102 includes one or more central processing units (CPU) 104 (only one is shown), a memory 106, non-volatile storage 108, an operating system 110, and a network adapter 112. An application program 114 further executes in memory 106 and is capable of transmitting and receiving packets from a remote computer. The computer 102 may comprise any computing device known in the art, such as a mainframe, server, personal computer, workstation, laptop, handheld computer, telephony device, network appliance, virtualization device, storage controller, network controller, etc. Any CPU 104 and operating system 110 known in the art may be used. Programs and data in memory 106 may be swapped into storage 108 as part of memory management operations.

The network adapter 112 includes a network protocol layer 116 to send and receive network packets to and from remote devices over a network 118. The network 118 may comprise a Local Area Network (LAN), the Internet, a Wide Area Network (WAN), Storage Area Network (SAN), etc. Embodiments may be configured to transmit data over a wireless network or connection, such as wireless LAN, Bluetooth, etc. In certain embodiments, the network adapter 112 and various protocol layers may implement the Ethernet protocol including Ethernet protocol over unshielded twisted pair cable, token ring protocol, Fibre Channel protocol, Infiniband, Serial Advanced Technology Attachment (SATA), parallel SCSI, serial attached SCSI cable, etc., or any other network communication protocol known in the art.

A device driver 120 executes in memory 106 and includes network adapter 112 specific commands to communicate with a network controller of the network adapter 112 and interface between the operating system 110, applications 114 and the network adapter 112. The network controller can implement the network protocol layer 116 and can control other protocol layers including a data link layer and a physical layer which includes hardware such as a data transceiver. In an embodiment employing the Ethernet protocol, the data transceiver could be an Ethernet transceiver.

In certain implementations, the network controller of the adapter 112 includes a transport protocol layer 121 as well as the network protocol layer 116 and other protocol layers. For example, the network controller of the network adapter 112 can implement a TCP/IP offload engine (TOE), in which many transport layer operations can be performed within the offload engines of the transport protocol layer 121 implemented within the network adapter 112 hardware or firmware, as opposed to the device driver 120, operating system 110 or an application 114.

The transport protocol operations include packaging data in a TCP/IP packet with a checksum and other information and sending the packets. These sending operations are performed by an agent which may be implemented with a TOE, a network interface card or integrated circuit, a driver, TCP/IP stack, a host processor or a combination of these elements. The transport protocol operations also include receiving a TCP/IP packet from over the network and unpacking the TCP/IP packet to access the payload or data. These receiving operations are performed by an agent which, again, may be implemented with a TOE, a driver, a host processor or a combination of these elements.

The network layer 116 handles network communication and provides received TCP/IP packets to the transport protocol layer 121. The transport protocol layer 121 interfaces with the device driver 120, or operating system 110 or application 114 and performs additional transport protocol layer operations, such as processing the content of messages included in the packets received at the network adapter 112 that are wrapped in a transport layer, such as TCP and/or IP, the Internet Small Computer System Interface (iSCSI), Fibre Channel SCSI, parallel SCSI transport, or any transport layer protocol known in the art. The transport offload engine 121 can unpack the payload from the received TCP/IP packet and transfer the data to the device driver 120, operating system 110 or an application 114.

In certain implementations, the network controller and network adapter 112 can further include an RDMA protocol layer as well as the transport protocol layer 121. For example, the network adapter 112 can implement an RDMA offload engine, in which RDMA layer operations are performed within the offload engines of the RDMA protocol layer implemented within the network adapter 112 hardware, as opposed to the device driver 120, operating system 110 or an application 114.

Thus, for example, an application 114 transmitting messages over an RDMA connection can transmit the message through the device driver 120 and the RDMA protocol layer of the network adapter 112. The data of the message can be sent to the transport protocol layer 121 to be packaged in a TCP/IP packet before transmitting it over the network 118 through the network protocol layer 116 and other protocol layers including the data link and physical protocol layers.

The memory 106 further includes file objects 124, which also may be referred to as socket objects, which include information on a connection to a remote computer over the network 118. The application 114 uses the information in the file object 124 to identify the connection. The application 114 would use the file object 124 to communicate with a remote system. The file object 124 may indicate the local port or socket that will be used to communicate with a remote system, a local network (IP) address of the computer 102 in which the application 114 executes, how much data has been sent and received by the application 114, and the remote port and network address, e.g., IP address, with which the application 114 communicates. Context information 126 comprises a data structure including information the device driver 120, operating system 110 or an application 114, maintains to manage requests sent to the network adapter 112 as described below.

In the illustrated embodiment, the CPU 104 programmed to operate by the software of memory 106 including one or more of the operating system 110, applications 114, and device drivers 120 provides a host which interacts with the network adapter 112. Accordingly, a data send and receive agent includes the transport protocol layer 121 and the network protocol layer 116 of the network interface 112. However, the data send and receive agent may be implemented with a TOE, a network interface card or integrated circuit, a driver, TCP/IP stack, a host processor or a combination of these elements.

FIG. 3 illustrates a format of a network packet 150 received at or transmitted by the network adapter 112. A message or message segment may include one or many such packets 150. The network packet 150 is implemented in a format understood by the network protocol 114 such as the IP protocol. The network packet 150 may include an Ethernet frame that would include additional Ethernet components, such as a header and error checking code (not shown). A transport packet 152 is included in the network packet 150. The transport packet 152 is capable of being processed by a transport protocol layer 121, such as the TCP protocol. The packet 152 may be processed by other layers in accordance with other protocols including Internet Small Computer System Interface (iSCSI) protocol, Fibre Channel SCSI, parallel SCSI transport, etc. The transport packet 152 includes payload data 154 as well as other transport layer fields, such as a header and an error checking code. The payload data 154 includes the underlying content being transmitted, e.g., commands, status and/or data. The driver 120, operating system 110 or an application 114 may include a layer, such as a SCSI driver or layer, to process the content of the payload data 154 and access any status, commands and/or data therein.

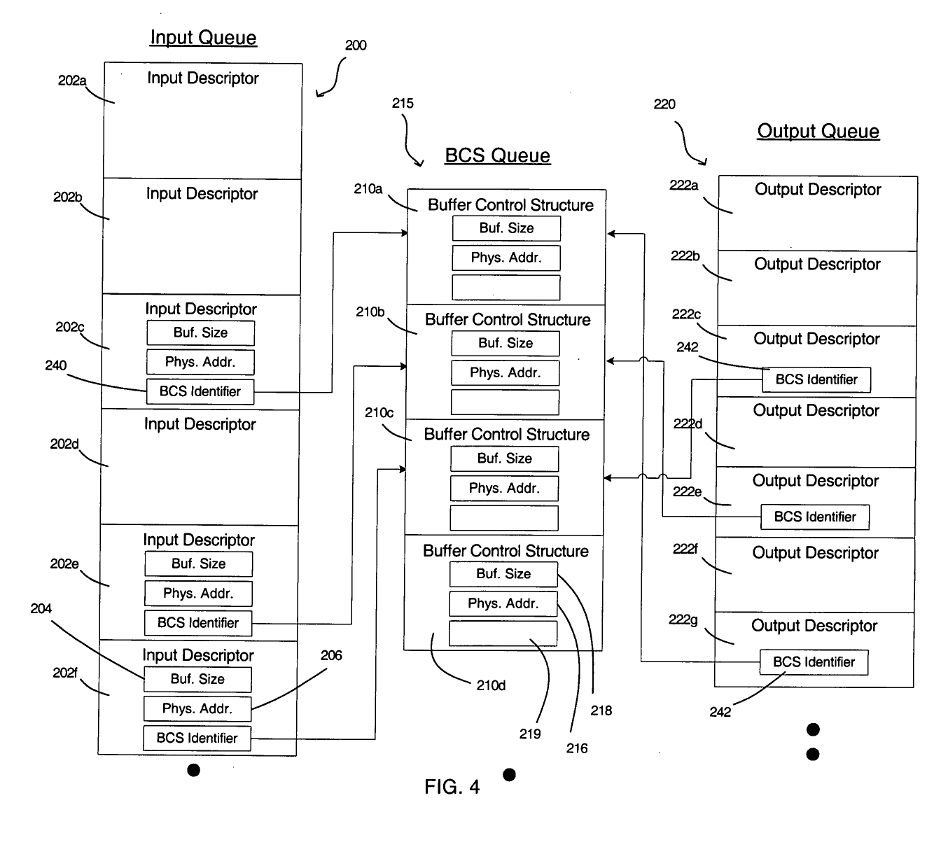

FIG. 4 shows an example of an input queue 200 for a network adapter such as the adapter 112 of FIG. 2. The input queue 200 may be implemented in the host memory 106, for example, or in another memory, depending upon the particular application. The adapter 112 includes one or more offload engines to implement the protocol layers 121, 122 and hence is capable of performing a variety of tasks. Thus, in this embodiment, the input queue 200 contains a variety of different kinds of input descriptors 202a, 202b . . . including input descriptors 202a, 202b and 202d for various offload engine operations. The input descriptors also includes buffer input descriptors such as buffer input descriptors 202c, 202e and 202f, for example. Each buffer input descriptor includes a size field 204 and a physical address field 206 which define the size and physical address, respectively of the associated buffer of the buffer input descriptor. Thus, the buffers associated with the buffer input descriptors 202c, 202e and 202f may have various sizes and may be used for a variety of operations in addition to being used as a receive buffer to store a received packet.

Each buffer referenced by the buffer input descriptors 202c, 202e, 202f . . . has an associated control structure 210a, 210b . . . which, in the illustrated embodiment, is queued in a control structure queue 215. The output queue 210, like the input queue 200, may be implemented in the host memory 106, for example, or in another memory, depending upon the particular application. Each buffer control structure 210a, 210b . . . has various fields including a buffer physical address field 216, a size field 218, and other fields such as virtual address and packet structure information as represented by fields 219.

As the network adapter 112 completes an operation associated with an input descriptor queued in the input queue 200, the network adapter stores in an output queue 220 an output completion descriptor 222a, 222b . . . The output queue 220, like the input queue 200, may be implemented in the host memory 106, for example, or in another memory, depending upon the particular application. Because of the widely varying nature of the offload engine operations and buffers described in the input descriptors 202a, 202b . . . queued in the input queue 200, the network adapter 112 may not complete the input descriptors 202a, 202b . . . in the same order in which they are queued on the input queue 200. As a consequence, the output completion descriptors 222a, 222b . . . queued in the output queue 220 may be queued in an order substantially different from the order in which the associated input descriptors 202a, 202b . . . are queued in the input queue 200. Thus, the driver 120 may, in some applications, be unable to determine which control structure is associated with a particular buffer of a particular output descriptor 222a, 222b . . . based upon the position of that output descriptor in the output queue 220.

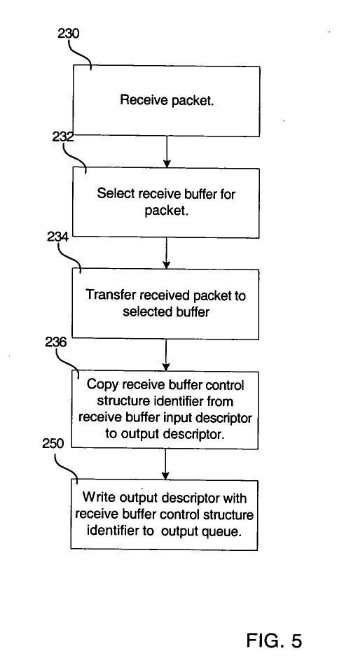

FIG. 5 shows an example of operations of a network adapter 112 in processing a received packet from the network 118, for example. Upon receipt (block 230) of a packet, the storage controller of the adapter 112 accesses the input queue 200 to select (block 232) one of the buffers posted in the input queue 200. Because the buffers of the input queue 200 vary in size, the network adapter may not select the buffers in the order in which their associated input descriptors 202c, 202e and 202f are queued in the input queue 200. Once a buffer is selected, the network adapter 112 obtains the receive buffer physical address from the associated input descriptor 202c, 202e and 202f of the input queue 200 and stores (block 234) the received packet in the receive buffer at the specified physical address.

In accordance with one aspect, the buffer descriptors 202c, 202e and 202f also include a buffer control structure identifier field 240 (FIG. 4) which, as explained in greater detail below, identifies the associated control structure of the control structures 210a, 210b . . . queued in the control structure queue 215. This control structure identifier is passed back to the device driver 120 to assist the device driver 120 in identifying the control structure of the buffer for a completed operation by the network adapter 112. Thus, upon transferring the (block 234) the received packet to the receive buffer at the specified physical address, the network adapter 112 copies (block 236) the control structure identifier field 240 obtained from the selected receive buffer input descriptor of the input descriptors 202c, 202e and 202f, to a corresponding field 242 of an output completion descriptor. This output completion descriptor is then written (block 250) with the included buffer control structure identifier field 242 to the output queue 220. In one embodiment, the physical address of the buffer can be omitted from the output completion descriptor.

As output completion descriptors are written to the output queue 220 by the network adapter 112, the device driver 120 begins (block 300) the processing of the output queue 220. In one embodiment, the device driver 120 may examine the output completion descriptors 222a, 222b . . . in the order in which they are queued on the output queue 220. Thus, the device driver 120 examines (block 302) the next output completion descriptor in the output queue 220. If the examined output descriptor is an output descriptor such as output descriptor 222a or 222b, which does not involve a buffer (block 304), the output descriptor 222a, 222b is processed (block 306) by the device driver 120 in accordance with the type of the completed operation described by the output descriptor A, B being examined.

On the other hand, if the examined output descriptor is an output descriptor such as output descriptor 222c, 222e or 222g, which indicates (block 304) that a buffer has been filled, the device driver 120 extracts (block 308) the buffer control structure identifier from the field 242 of the output descriptor being examined.

As shown in FIG. 4, each buffer control structure identifier field 242 of each output completion descriptor 222c, 222e or 222g uniquely identifies a particular control structure of control structures 210a, 210b . . . n of the control structure queue 215. Thus, in the example of FIG. 4, the buffer control structure identifier field 242 of the output completion descriptor C uniquely identifies the associated control structure 3 of the control structure queue 215. Similarly, the buffer control structure identifier field 242 of the output completion descriptor E uniquely identifies the associated control structure 2 of the control structure queue 215. Similarly, the buffer control structure identifier field 242 of the output completion descriptor 222g uniquely identifies the associated control structure 1 of the control structure queue 215.

The buffer control structure identifier fields 240, 242 of the input descriptor and the output completion descriptor, respectively, may identify the associated buffer control structure in various ways, depending upon the particular application. For example, a buffer control structure identifier field 240, 242 may contain a pointer such as the virtual address of the identified buffer control structure. Alternatively, the buffer control structure identifier field 240, 242 may contain an index to the position of the buffer control structure in the queue 215. Still further, the buffer control structure identifier field 240, 242 may contain an entry to a table of buffer control structure identifiers.

Using the particular buffer control structure 210a, 210b . . . n identified by the buffer control structure identifier field 242 of the output descriptor being examined, the device driver 120 can process (block 320) the data contained in the buffer. This data may be for example a received packet.

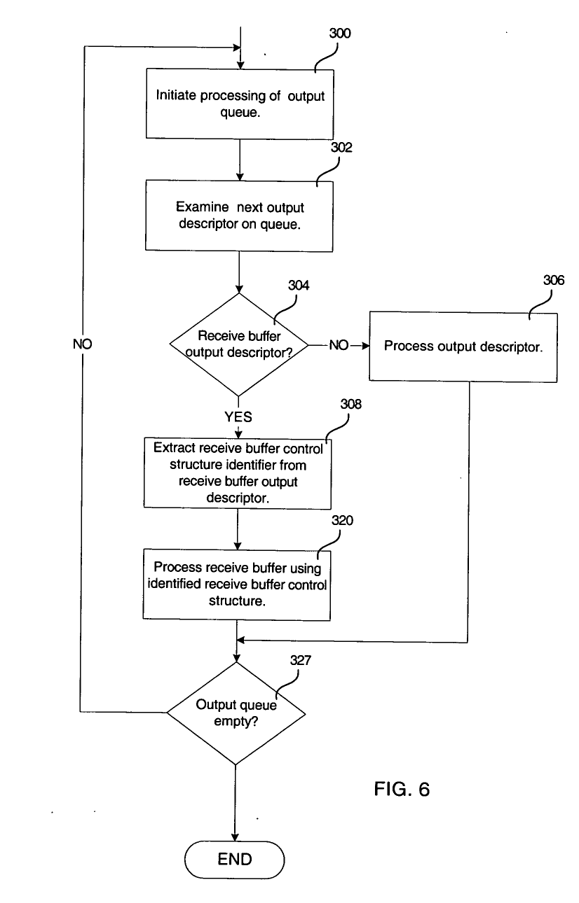

If the output queue has not been fully processed such that unprocessed output descriptors remain in the output queue 220 (bock 322), another output descriptor is examined (block 302) and the process (blocks 302-322) is repeated for each remaining output descriptor in the queue 220. Once all output descriptors have been processed (block 322), the device driver processing of FIG. 6 is ended until new output completion descriptors are added to the output queue 220.

Additional Embodiment Details

The described techniques for managing memory may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

In the described embodiments, certain operations were described as being performed by the operating system 110, system host 130, device driver 120, or the network interface 112. In alterative embodiments, operations described as performed by one of these may be performed by one or more of the operating system 110, device driver 120, or the network interface 112. For example, memory operations described as being performed by the driver may be performed by the host.

In the described implementations, a transport protocol layer 121 was implemented in the network adapter 112 hardware. In alternative implementations, the transport protocol layer may be implemented in the device driver or host memory 106.

In the described embodiments, various protocol layers and operations of those protocol layers were described. The operations of each of the various protocol layers may be implemented in hardware, firmware, drivers, operating systems, applications or other software, in whole or in part, alone or in various combinations thereof.

In the described embodiments, the packets are transmitted from a network adapter to a remote computer over a network. In alternative embodiments, the transmitted and received packets processed by the protocol layers or device driver may be transmitted to a separate process executing in the same computer in which the device driver and transport protocol driver execute. In such embodiments, the network adapter is not used as the packets are passed between processes within the same computer and/or operating system.

In certain implementations, the device driver and network adapter embodiments may be included in a computer system including a storage controller, such as a SCSI, Integrated Drive Electronics (IDE), Redundant Array of Independent Disk (RAID), etc., controller, that manages access to a non-volatile storage device, such as a magnetic disk drive, tape media, optical disk, etc. In alternative implementations, the network adapter embodiments may be included in a system that does not include a storage controller, such as certain hubs and switches.

In certain implementations, the device driver and network adapter embodiments may be implemented in a computer system including a video controller to render information to display on a monitor coupled to the computer system including the device driver and network adapter, such as a computer system comprising a desktop, workstation, server, mainframe, laptop, handheld computer, etc. Alternatively, the network adapter and device driver embodiments may be implemented in a computing device that does not include a video controller, such as a switch, router, etc.

In certain implementations, the network adapter may be configured to transmit data across a cable connected to a port on the network adapter. Alternatively, the network adapter embodiments may be configured to transmit data over a wireless network or connection, such as wireless LAN, Bluetooth, etc.

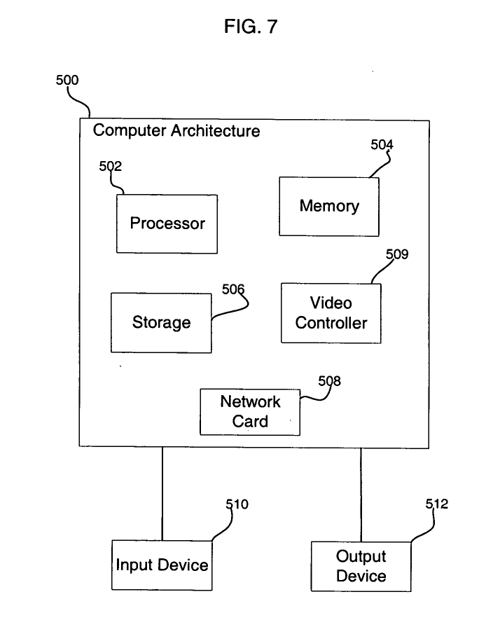

The illustrated logic of FIGS. 7-10 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

FIG. 6 illustrates information used to manage memory space. In alternative implementation, these data structures may include additional or different information than illustrated in the figures.

FIG. 11 illustrates one implementation of a computer architecture 500 of the network components, such as the hosts and storage devices shown in FIG. 4. The architecture 500 may include a processor 502 (e.g., a microprocessor), a memory 504 (e.g., a volatile memory device), and storage 506 (e.g., a non-volatile storage, such as magnetic disk drives, optical disk drives, a tape drive, etc.). The storage 506 may comprise an internal storage device or an attached or network accessible storage. Programs in the storage 506 are loaded into the memory 504 and executed by the processor 502 in a manner known in the art. The architecture further includes a network adapter 508 to enable communication with a network, such as an Ethernet, a Fibre Channel Arbitrated Loop, etc. Further, the architecture may, in certain embodiments, include a video controller 509 to render information on a display monitor, where the video controller 509 may be implemented on a video card or integrated on integrated circuit components mounted on the motherboard. As discussed, certain of the network devices may have multiple network cards or controllers. An input device 510 is used to provide user input to the processor 502, and may include a keyboard, mouse, pen-stylus, microphone, touch sensitive display screen, or any other activation or input mechanism known in the art. An output device 512 is capable of rendering information transmitted from the processor 502, or other component, such as a display monitor, printer, storage, etc.

The network adapter 508 may be implemented on a network card, such as a Peripheral Component Interconnect (PCI) card or some other I/O card, or on integrated circuit components mounted on the motherboard.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

1. A method, comprising:
receiving a packet from a network;
selecting a receive buffer from an input queue of input descriptors which includes a plurality of receive buffer input descriptors in which each receive buffer input descriptor includes the physical address of a receive buffer and a control structure identifier of a control structure associated with the receive buffer associated with the receive buffer input descriptor;
transferring the received packet to the selected receive buffer, and
storing a receive buffer control structure identifier in a receive buffer output descriptor as a function of the control structure identifier of the receive buffer input descriptor of the selected buffer.

2. The method of claim 1 wherein said storing a receive buffer control structure identifier comprises copying the control structure identifier of the receive buffer input descriptor of the selected buffer to a receive buffer output descriptor so that said stored receive buffer control structure identifier is the same as the control structure identifier of the receive buffer input descriptor of the selected buffer.

3. The method of claim 1 wherein said stored buffer control structure identifier is the virtual address of the control structure of the selected buffer.

4. The method of claim 1 wherein said stored receive buffer control structure identifier is an index into any array of said control structures.

5. The method of claim 3 wherein the control structure identifier of the receive buffer input descriptor of the selected buffer is the virtual address of the control structure of the selected buffer.

6. The method of claim 1 further comprising storing the receive buffer output descriptor in an output queue of output descriptors which includes a plurality of receive buffer output descriptors in which each receive buffer output descriptor includes a stored control structure identifier of a control structure associated with the receive buffer associated with the receive buffer output descriptor.

7. The method of claim 6 further comprising reading a receive buffer output descriptor front said output queue and processing the packet transferred to the receive buffer of the read receive buffer output descriptor using the receive buffer control structure identified by the receive buffer control structure identifier of the read receive buffer output descriptor.

8. The method of claim 1 wherein sad receiving, selecting, transferring and storing are performed by a net work adapter.

9. The method of claim 7 wherein said receive buffer output descriptor reading and said processing are performed by a driver for a network adapter.

10. The method of claim 1 wherein a portion of said input descriptors include transport offload engine commands.

11. The method of claim 1 wherein each receive buffer output descriptor lacks the physical address of the associated receive buffer.

12. An article comprising a storage medium, the storage medium comprising machine readable instructions stored thereon to:
receive a packet from a network;
select a receive buffer from an input queue of input descriptors which include a plurality of receive buffer input descriptors in which each receive buffer input descriptors includes the physical address of a receive buffer and a control structure identifier of a control structure associated with the receive buffer associated with the receive buffer input descriptor;
transfer the received packet to the selected receive buffer; and
store a receive buffer control structure identifier in a receive buffer output descriptor as a function of the control structure identifier of the receive buffer input descriptor of the selected buffer.

13. The article of claim 12 wherein the machine readable instructions to store a receive buffer control structure identifier include machine readable instructions stored on the storage medium to copy the control structure identifier of the receive buffer input descriptor of the selected buffer to a receive buffer output descriptor so that said stored receive buffer control structure identifier is the same as the control structure identifier of the receive buffer input descriptor of the selected buffer.

14. The article of claim 12 wherein said stored receive buffer control structure identifier is the virtual address of the control structure of the selected buffer.

15. The article of claim 12 wherein said stored receive buffer control structure identifier is an index into an array of said control structures.

16. The article of claim 14 wherein the control structures identifier of the receive buffer input descriptor of the selected buffer is the virtual address of the control structure of the selected buffer.

17. The article of claim 12 wherein the storage medium further comprises machine readable instructions stored thereon to:
store the receive buffer output descriptor in an output queue of output descriptors which include a plurality of receive buffer output descriptors in which each receive buffer output descriptor includes a stored control structure identifier of a control structure associated with the receive buffer associated with the receive buffer out put descriptor.

18. The article of claim 17 wherein the storage medium further comprises machine readable instructions stored thereon to:
read a receive buffer output descriptor from said output queue and process the packet transferred to the receive buffer of the read receive buffer output descriptor using the receive buffer control structure identified by the receive buffer control structure identifier of the read receive buffer output descriptor.

19. The article of claim 12 wherein said instructions to receive, select, transfer and store are performed by a network adapter.

20. The article of claim 18 wherein said instruction to read a receive buffer output descriptor and said process the packet are performed by a driver for a network adapter.

21. The article of claim 12 wherein a portion of said input descriptors include transport offload engine commands.

22. The article of claim 12 wherein each receive buffer output descriptor lacks the physical address of the associated receive buffer.

23. A system, comprising:
at least one memory which includes an operating system, a plurality of receive buffers and a plurality of control structures wherein each control structure is associated with a receive buffer;
a processor coupled to the memory;
a network controller;
data storage;
a data storage controller for managing Input/Output (I/O) access to the data storage; and
a device driver for said network controller and executable by the processor in the memory, wherein at least one of the operating system, device driver and the network controller includes an input queue of input descriptors which includes a plurality of receive buffer input descriptors in which each receive buffer input descriptor includes the physical address of a receive buffer and a control structure identifier of a control structure associated with the receive buffer associated with the receive buffer input descriptor, and an output queue which includes a plurality of receive buffer output descriptors, and wherein at least one of the operating system, device driver and the network controller is adapted to:
receive a packet from a network;
select a receive buffer from said input queue of receive buffer input descriptors;
transfer the received packet to the selected receive buffer; and
store a receive buffer control structure identifier in a receive buffer output descriptor as a function of the control structure identifier of the receive buffer input descriptor of the selected buffer.

24. The system of claim 23 wherein said storing a receive buffer control structure identifier comprises copying the control structure identifier of the receive buffer input descriptor of the selected buffer to a receive buffer output descriptor so that said stored receive buffer control structure identifier is the same as the control structure identifier of the receive buffer input descriptor of the selected buffer.

25. The system of claim 23 wherein said stored receive buffer control structure identifier is the virtual address of the control structure of the selected buffer.

26. The system of claim 23 wherein said control structure are arrayed in an array and wherein said stored receive buffer control structure identifier is an index into said array of said control structures.

27. The system of claim 25 wherein the control structure identifier of the receive buffer input descriptor of the selected buffer is te virtual address of the control structure of the selected buffer.

28. The system of claim 23 wherein each receive buffer output descriptor includes a stored control structure identifier of a control structure associated with the receive buffer associated with the receive buffer output descriptor.

29. The system of claim 28 wherein at least one of the operating system, device driver and the network controller is adapted to:
read a receive buffer output descriptor from said output queue and process the packet transferred to the receive buffer of the read receive buffer output descriptor using the receive buffer control structure identified by the receive buffer control structure identifier of the read receive buffer output descriptor.

30. The system of claim 23 wherein said receiving, selecting. transferring and storing are performed by said network controller.

31. The system of claim 29 wherein said receive buffer output descriptor reading and said processing are performed by said driver.

32. The system of claim 23 wherein a portion of said input descriptors include transport offload engine commands.

33. The system of claim 23 wherein each receive buffer output descriptor lacks the physical address of the associated receive buffer.

34. The system of claim 23 for use with an unshielded twisted pair cable, said system further comprising an Ethernet data transceiver coupled to said network controller and said cable and adapted to transmit and receive data over said cable.

35. The system of claim 23 further comprising a video controller coupled to said processor.

36. A network adapter for use with a network a plurality of receive buffers and a plurality of control structures wherein each control structure is associated with a receive buffer comprising:
an input queue of input descriptors which includes a plurality of receive buffer input descriptors in which each receive buffer input descriptor includes the physical address of a receive buffer and a control structure identifier of a control structure associated with the receive buffer associated with the receive buffer input descriptor, and
an output queue which includes a plurality of receive buffer output descriptors, and wherein said network adapter is adapted to:
receive a packet from a network;
select a receive buffer from said input queue of receive buffer input descriptors;
transfer the received packet to the selected receive buffer; and
store a receive buffer control structure identifier in a receive buffer output descriptor as a function of the control structure identifier of the receive buffer input descriptor of the selected buffer.

37. The net work adapter of claim 36 wherein said storing a receive buffer control structure identifier comprises copying the control structure identifier of the receive buffer input descriptor of the selected buffer to a receive buffer output descriptor so that said stored receive buffer control structure identifier is the same as the control structure identifier of the receive buffer input descriptor of the selected buffer.

38. The network of claim 36 wherein said stored receive buffer control structure identifier is the virtual address of the control structure of the selected buffer.

39. The network adapter of claim 36 wherein said control structures are arrayed in an array and wherein said stored receive buffer control structure identifier is an index into said array of said control structures.

40. The network adapter of claim 38 wherein the control structure identifier of the receive buffer input descriptor of the selected buffer is the virtual address of the control structure of the selected buffer.

41. The network adapter of claim 36 wherein each receive buffer output descriptor includes a stored control structure identifier of a control structure associated with the receive buffer associated with the receive buffer output descriptor.

42. The network adapter of claim 36 wherein a portion of said input descriptors include transport offload engine commands.

43. The network adapter of claim 36 wherein each receive buffer output descriptor lacks the physical address of the associated receive buffer.
